(19) United States
(12) Patent Application Publication
(10) Pub. No.: US 2015/0132715 A1
(43) Pub. Date: May 14, 2015

(54) Vibrative Anesthesia Device for Pain Reducing

(71) Applicants: Tai-Jung Yeh, Taipei City (TW); Keng-Liang Ou, Taipei City (TW); Yu-Hao Chan, Taipei City (TW); Han-Yi Cheng, Taipei City (TW)

(72) Inventors: Tai-Jung Yeh, Taipei City (TW); Keng-Liang Ou, Taipei City (TW); Yu-Hao Chan, Taipei City (TW); Han-Yi Cheng, Taipei City (TW)

(21) Appl. No.: 14/077,213

(22) Filed: Nov. 12, 2013

(51) Int. Cl. A61C 19/08

(52) U.S. Cl. CPC A61C 19/08
USPC 433/118

(57) ABSTRACT

A vibrative anesthesia device for pain reducing comprises: a grip, for hand gripping; an electrical component, set inside of the grip with a protruding cable; a vibration component, electrically connected with the electrical component for setting in the oral cavity; thereby, with vibration generated by the vibration component, pain reducing or painless feeling are archieved.

### FIELD OF THE INVENTION

The present invention relates to a vibrative anesthesia device for pain reducing, particularly to a vibrative anesthesia device, which reduces pain caused by injection by means of vibration, for example, during anesthesic injection in the oral cavity.

### BACKGROUND OF THE INVENTION

Comfort and pain reducing for patients are of principal importance in the field of medical safety. Transmission of stimuli by a variety of peripheral nerves can effectively reduce pain feeling of patients.

Peripherial nerves of the human body are different in nature, therefore the feeling transmitted by them are also different. Peripheral nerves for transmitting temperature and pain are very tiny, non-isolated and of low signal density, while peripheral nerves for transmitting pressure and vibration are thicker, isolated and of high signal density. Therefore, when pain and vibration occur at the same time, vibration signals transmitted by the isolated nerves will control the pain feeling transmitted by non-isolated nerves. At this time patient feels almost only the vibration, while the pain feeling is reduced. Patient feels even painless. That is the “Gate Control Theory”.

By the Gate Control Theory for inhibiting pain, surface anesthesia is not necessary. A device for pain reducing by means of vibrative anesthesia generates high-frequency-vibration, and furthermore stimulates peripheral nerves to transmitte vibration, and prevent pain feeling from being tranmitted to the brain, thus comfort and savety of a patient is upgraded.

Taiwan Utility Model Patent Bulletin No. M443510 disclosures a “Handheld Device for Pain Reducing” for reducing pain feeling of a patient. However, this device has following disadvantages: 1. high production costs, since the structure of the device is complicated; 2. fields of application are limited, due to the that ring-shape it can only be used for injection on a flat surface, but not for injection in an oral cavity or at bumpy parts.

### SUMMARY OF THE INVENTION

The main object of the present invention is to provide a vibrative anesthesia device for pain reducing, which has a simple structure and is usable in an oral cavity, wherein pain reducing or even painless feeling of a patient are achieved.

For achieving above object, a vibrative anesthesia device for pain reducing of the present invention comprises: a grip for hand gripping; an electrical component set inside of said grip, with a protruding cable; a vibration component, connected with the cable of the electrical component, usable for setting in oral cavity; with vibration generated by the vibration component, so that pain reducing or painless feeling are archieved.

It is preferred that the grip has a control switch for starting or dosing the vibration component.

The control switch can control the amplitude and/or frequency of the vibration component, so that the controller can adjust the amplitude and/or frequency according to a using situation.

For easy operating the electrical component is a battery.

It is preferred that the vibration component comprises: a case, having a predetermined shape; and a driver, set inside of the case, electrically connected with that electrical component; by choosing different shapes of case, different requirements are satisfied.

The ease has an elliptic shape, which is appropriate for setting in an oral cavity.

The grip has a duct, which coates the cable outsides, for protecting said cable.

Said duct is a rigid body, for easy controlling of the location of the vibration component.

Said duct is as a flexible body, for easy operating.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a partial sectional view of the present invention.

FIG. 2. is a partial sectional view of the vibration component of the present invention.

FIG. 3 is the second embodiment of the present invention, wherein there is a partial sectional view of the grip coated with a duct.

### DESCRIPTION OF THE PREFERRED EMBODIMENTS

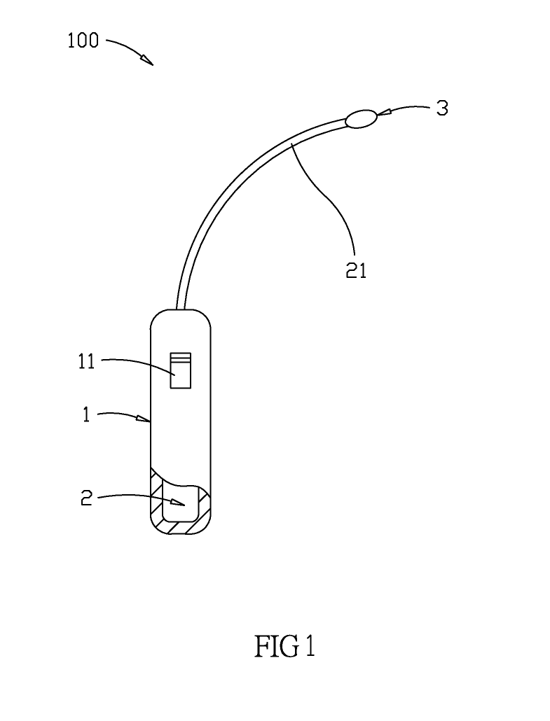

As shown in FIG. 1, the vibrative anesthesia device for pain reducing 100 of the present invention comprises: a grip 1 for hand gripping: an electrical component 2, set inside of the grip 1 with a protruding cable 21; a vibration component 3, electrically connected with the cable 21 of said electrical component 2, which can be set in an oral cavity; with vibration generated by the vibration component, pain reducing or painless feeling of a patient are archieved.

The grip 1 for hand gripping, having a control switch 11 for starting or closing the vibration component 3, wherein the control switch 11 can control the amplitude and/or frequency of the vibration component 3, thus it is easy for user to adjust the amplitude and/or frequency.

Owing to easy operating the electrical component 2 is a battery, a protruding cable 21 is used for electrical connection with the vibration component 3. Besides, the electrical component 2 can also be a rechargeable power device for using charger (not shown), or an external power supply device, as alternative for the user according to the requirements.

As shown in FIG. 2, the vibration component 3 comprises: a case 31, having a predetermined shape; a driver 32 set inside of the case 31, electircally connected with the electrical component 2; wherein the vibration component 3 generates vibration, which causes pain reducing or painless feeling, wherein selection of different case shapes according to different requirements is available, for example, ellipse- or crescent-shaped case (not shown). Besides, the case 31 is a soft conductor (not shown), for easy filling between gums and lips, for mitigating discomfort. For generating vibration a driver 32 is used. Its sturckture is a conventional art, is hier not described.

In practice, setting the vibration component 3 between gums and lips, then starting the vibration component 3 for patient to feel vibrative, thereafter by anesthetical injection pain reducing or painless feeling is achieved. Therein the grip 1, electrical component 2 and the vibration component 3 are simple, light structured, easily to use, therefore producing and material costs are saved.

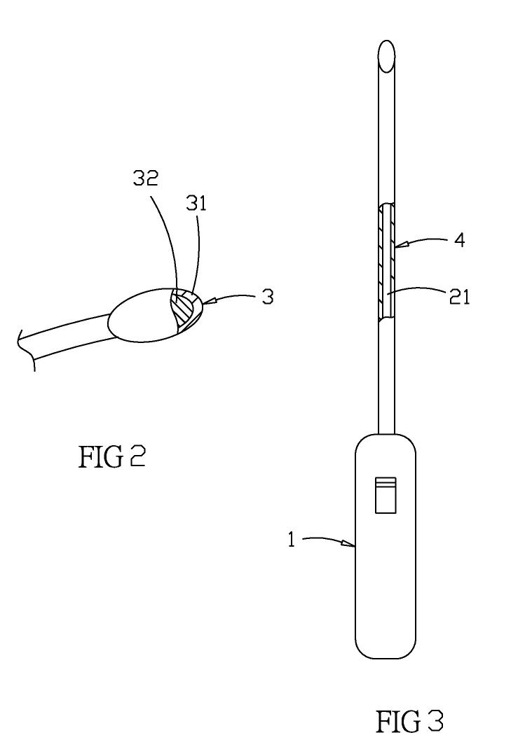

FIG. 3 shows the second embodiment of the present invention, an the grip 1 there is a duct 4, which coates outside of the cable 21 for protecting the cabel 21. The duct 4 is a rigid body, by reason of easy operating the vibration component 3. It is also a flexible body (not shown), for of easy operating and preventing discomfort due to grip or duct.

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A vibrative anesthesia device for pain reducing comprising:
a grip, for hand gripping;
an electrical component, set inside of the grip, with a protruding cable;
a vibration component, electrically connected with the cable of the electrical component, for setting in an oral cavity.

2. The vibrative anesthesia device for pain reducing of claim 1, wherein said grip has a control switch for starting or closing said vibration component.

3. The vibrative anesthesia device for pain reducing of claim 2, wherein said control switch controls the amplitude and/or frequency of said vibration component.

4. The vibrative anesthesia device for pain reducing of claim 1, wherein said electrical component is a battery.

5. The vibrative anesthesia device for pain reducing of claim 1, wherein said electrical component is a rechargeable power device or an external power supply device.

6. The vibrative anesthesia device for pain reducing of claim 1, wherein said vibration component comprises: a case with a predetermined shape; a driver set inside of the case and electrically connected with said electrical component.

7. The vibrative anesthesia device for pain reducing of claim 6, wherein said case is an elliptically-shaped shell.

8. The vibrative anesthesia device for pain reducing of claim 1, wherein said grip has a duct coating outside of said cable.

9. The vibrative anesthesia device for pain reducing of claim 8, wherein said duct is a rigid body.

10. The vibrative anesthesia device for pain reducing of claim 8, wherein said duct is a flexible body.
